(19) United States
(12) Patent Application Publication
(10) Pub. No.: US 2015/0039538 A1
(43) Pub. Date: Feb. 5, 2015

(54) METHOD FOR PROCESSING A LARGE-SCALE DATA SET, AND ASSOCIATED APPARATUS

(71) Applicants: Mohamed Hefeeda, Doha (QA); Wael Abd-Almageed, Woodstock, MD (US); Fei Gao, Vancouver (CA)

(72) Inventors: Mohamed Hefeeda, Doha (QA); Wael Abd-Almageed, Woodstock, MD (US); Fei Gao, Vancouver (CA)

(21) Appl. No.: 13/881,149

(22) PCT Filed: Jun. 1, 2012
(86) PCT No.: PCT/EP12/60406

§ 371 Date: May 14, 2014

(51) Int. Cl. G06F 17/30; G06N 99/00

(52) U.S. Cl. CPC G06F 17/30289; G06N 99/005
USPC 706/12

(57) ABSTRACT

A method for processing at least part of a large-scale dataset, the method comprising: receiving a dataset including a plurality of data points; generating a hash value for at least some of the data points; sorting the generated hash values into a plurality of buckets of identical or substantially identical hash values; generating a similarity matrix for each of the buckets; and applying a machine learning algorithm to the similarity matrices.

### RELATED APPLICATION

This application is a National Stage under 35 U.S.C. §371 of International Patent Application No. PCT/EP2012/060406, filed Jun. 1, 2012, which is incorporated herein by reference in its entirety.

### BACKGROUND INFORMATION

With the decrease in storage costs, the decrease in sensor costs, and the increase in computing performance, large-scale datasets are now commonplace in many fields.

Fields in which large datasets are of particular importance at present include computer vision, bioinformatics, and natural language processing, but it is expected that such datasets will become important in many other fields too.

Such datasets, however, pose processing difficulties due to their size and complexity. Machine learning algorithms have been used recently in order to process the data in large-scale datasets. However, the implementation of machine learning algorithms for large-scale dataset processing is not straightforward due to the size and complexity of the datasets.

Furthermore, many existing algorithms are unable to support larger datasets and will not be sufficient to handle the expected increase in the size and complexity of large-scale datasets in the future.

In particular, many current machine learning algorithms rely on a kernel matrix (which stores pair-wise similarity values among all data points in a dataset). These kernel matrices are computationally expensive to generate both in terms of time and space. The complexities of the datasets also mean that distributed processing arrangements—e.g. using cloud computing platforms—are also difficult to implement. Therefore, the use of a kernel matrix is not considered to be feasible for datasets which may have millions, or even billions of data points.

Consequently, there is a need to provide a means by which large-scale datasets can be processed efficiently.

### SUMMARY OF THE DISCLOSURE

Accordingly an aspect of the present invention provides a method for processing at least part of a large-scale dataset, the method comprising: receiving a dataset including a plurality of data points; generating a hash value for at least some of the data points; sorting the generated hash values into a plurality of buckets of identical or substantially identical hash values; generating a similarity matrix for each of the buckets; and applying a machine learning algorithm to the similarity matrices.

The method may further comprise allocating each of the plurality of buckets to a one of a plurality of processing units, each processing unit being configured to generate a similarity matrix for at least one of the plurality of buckets.

A first of the plurality of buckets may be allocated to a first of the plurality of processing units, and a second of the plurality of buckets is allocated to a second of the plurality of processing units, the first and second processing units being different processing units.

Each processing unit may be remote from at least one other processing unit of the plurality of processing units.

The first and second processing units may be parts of the same computing device.

The first and second processing units may be parts of respective first and second computing devices.

The first and second computing devices may be part of a distributed processing network.

The distributed processing network may be a cloud computing network.

Generating the hash value may comprise applying a data-blind hashing technique.

Generating the hash value may comprise applying a locality sensitive hashing (LSH) technique.

Generating the hash value may comprise applying a random projection technique.

Generating the hash value may comprise applying a stable distribution technique.

Generating the hash value may comprise applying a Min-Wise Independent Permutations technique.

Generating the hash value may comprise applying a data-dependent hashing technique.

The machine learning algorithm may be a clustering algorithm.

Another aspect of the present invention provides a computer readable medium storing instructions which when run on a computing device cause the operation of a method disclosed herein.

Another aspect of the present invention provides a data bucket for use in a method disclosed herein.

Another aspect of the present invention provides an apparatus configured to processing at least part of a large-scale dataset, by: receiving a dataset including a plurality of data points; generating a hash value for at least some of the data points; sorting the generated hash values into a plurality of buckets of identical or substantially identical hash values; generating a similarity matrix for each of the buckets; and applying a machine learning algorithm to the similarity matrices.

The apparatus may include a plurality of processing units.

The apparatus may be further configured to allocating each of the plurality of buckets to a one of the plurality of processing units, each processing unit being configured to generate a similarity matrix for at least one of the plurality of buckets.

A first of the plurality of buckets may be allocated to a first of the plurality of processing units, and a second of the plurality of buckets is allocated to a second of the plurality of processing units, the first and second processing units being different processing units.

Each processing unit may be remote from at least one other processing unit of the plurality of processing units.

The first and second processing units may be parts of the same computing device.

The first and second processing units may be parts of respective first and second computing devices.

The first and second computing devices may be part of a distributed processing network.

The distributed processing network may be a cloud computing network.

Generating the hash value may comprise applying a data-blind hashing technique.

Generating the hash value may comprise applying a locality sensitive hashing (LSH) technique.

Generating the hash value may comprise applying a random projection technique.

Generating the hash value may comprise applying a stable distribution technique.

Generating the hash value may comprise applying a Min-Wise Independent Permutations technique.

Generating the hash value may comprise applying a data-dependent hashing technique.

The machine learning algorithm may be a clustering algorithm.

Another aspect of the present invention provides a cloud computing network including an apparatus.

### BRIEF DESCRIPTION OF THE DRAWINGS

Embodiments of the present invention are described herein, by way of example only, with reference to the accompanying drawings in which:

FIG. 1 is a flow diagram showing an overview of an embodiment of the invention; and

FIG. 2 depicts apparatus according to embodiments.

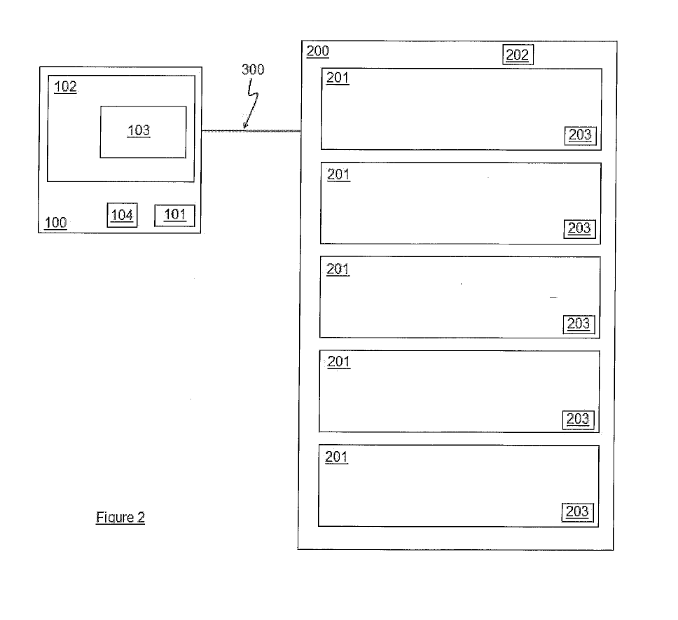

### DETAILED DESCRIPTION OF EMBODIMENTS

Embodiments of the present invention include algorithms and methods for processing data and, in particular, for processing large-scale datasets.

As used herein the term “large-scale dataset” may be construed as meaning a dataset with a large number of data points. For example, a large-scale dataset may include thousands, millions, or billions of data points.

The methods and algorithms are typically embodied as a computer program comprising a plurality of instructions which, when run on a computing device 100,200, cause the computing device 100,200 to perform the specified operations to implement the method or algorithm.

The computing device 100,200 may, for example, be a single machine 100 with, among other things, a central processing unit 104, memory, and various input/output interfaces. The computing device 100,200 may be coupled to a local and/or wide area network 300. The computing device 100,200 may have one or more user interface devices 101 and may include a display 102. The display 102 may be configured to display, to the user, one or more results from the operation of the program operating thereon and/or information pertaining to the progress in the operation of the program. The display 102 may be configured to display one or more of the graphic user interfaces 103 disclosed herein. The term “computing device” as used herein is a reference to a computing device capable of processing data in accordance with a computer program, rather than necessarily being a specific reference to a personal computer as such.

In embodiments, the methods and algorithms disclosed herein are configured for operation on a computing device 200 which itself comprises a network of computing devices 201 which may be configured in a cloud network or other distributed processing arrangement. Thus, as will be appreciated, different parts of the methods and algorithms disclosed herein may be operated on disparate computers which may be geographically isolated from each other.

Each computing device 100,200,201 includes at least one processing unit 104,202,203.

In embodiments, a first computing device 100 acts as a client which instructs a host computing device or system 200—wherein the host computing device or system 200 performs a substantial part of the implementation of the methods and algorithms.

In embodiments, implementations of the invention on disparate computing devices 201 may use, for example, the MapReduce or Hadoop framework.

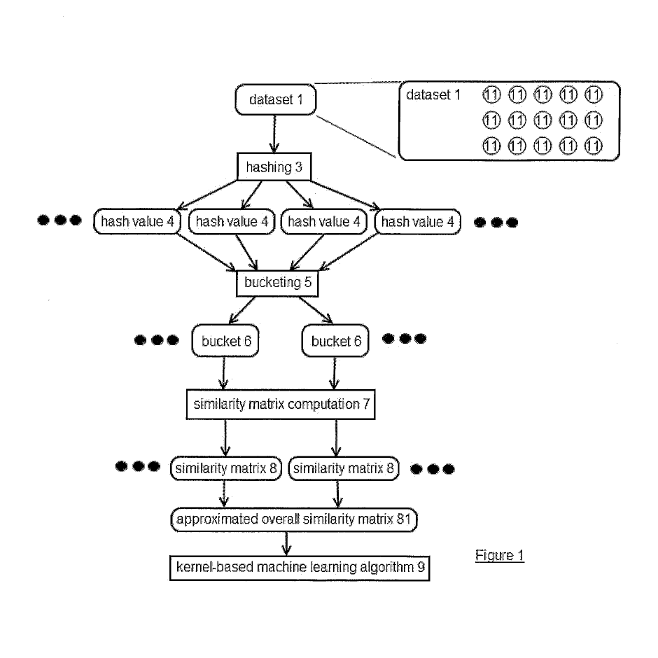

In a method according to an embodiment of the present invention, there is a four step distributed approximate processing method, which may be a distributed approximate spectral clustering (DASC) method, and which is generally depicted in the flow diagram shown in FIG. 1.

In accordance with the four step method, a dataset 1 is provided 2. The dataset 1 may be a large-scale dataset comprising thousands, millions, or billions of data points 11.

Providing the dataset 1 may comprise the entering, by a user, of information into a graphical user interface which allows a program to identify the dataset 1—for example, the information may comprise a filename, a directory name, server identifier, a pointer, an address of a storage medium, an address on a storage medium, or the like.

The dataset 1 is then analysed in a first step which is a hashing step 3. In accordance with the hashing step 3 a hash value 4 is generated for each data point 11 (X₁, . . . , X_{N} εR^{d}) in the dataset 1. In accordance with embodiments, respective hash values 4 are generated for only a subset of the data points 11 in the dataset 1 being analysed.

In embodiments, the hash values 4 are generated using a locality sensitive hashing (LSH) technique. The LSH technique may be a random projection technique, a stable distribution technique, or a Min-Wise Independent Permutations technique, for example.

In embodiments, the user may be presented with a graphical user interface will allows for the selection of a hashing technique from a plurality of available hashing techniques. In embodiments, the graphical user interface allows the user to enter information regarding the characteristics of the dataset 1 and/or the type of processing of the dataset 1 which is required. A program may, in such embodiment, identify an appropriate hashing technique from a plurality of techniques. The selection of an appropriate hashing technique may include the taking into account of the available resources—such as memory and/or processing power.

Random projection techniques also allow for the subsequent use of hamming distances, for which efficient algorithms are available, in order to identify identical or substantially identical hash values 4.

In the present example, using a random projection technique, an M-bit binary signature vector can be generated for the data points 11 of the dataset 1 (or a subset thereof). This signature vector is the hash value 4 for that data point 11.

Each bit of the signature vector is generated by the selection of an arbitrary dimension of the dataset (or part thereof) and the comparison of a feature value along this dimension to a threshold. If the dimension is larger than the threshold, then the bit is set to 1, otherwise the bit is set to 0.

In other embodiments, hash values 4 (i.e. the signature vectors) are generated using other techniques. For example, data-dependent hashing techniques may be used (LSH being generally a data-blind hashing technique).

Data-dependent hashing techniques which may be used include, for example, spectral hashing techniques. Such techniques may be particularly useful in relation to embodiments in which the invention is implemented over a distributed network of computers and in applications in which the data points 11 within the dataset 1 are not evenly distributed—in order to obtain buckets 6 in the bucketing step 5 (described below) which have a more even distribution of data points 11 therein than would be the case with a data-blind hashing technique.

For a given set of N data points, using a random projection hashing technique to generate an M-bit signature for each data point, the time complexity of the hashing is O(MN).

The second step of the four step method is a bucketing step 5 in which the hash values 4 generated by the hashing step 3 are analysed. If the hash values 4 are duplicates or near-duplicates of each other then they are grouped in the same notional bucket 6. In embodiments, in order to be near-duplicates of each other a substantial subset of the bits of each hash value 4 must be the same. The number of bits which must be the same in order for a first hash value 4 to constitute a near-duplicate of a second hash value 4 may be set in accordance with the desired accuracy of the method.

If the first step, the hashing step, generated T unique (or substantially unique) hash values 4, then the time complexity of the second step, the bucketing step, is O(T²).

Each bucket 6 may comprise a storage medium or part thereof. Each bucket 6 may comprise a contiguous or substantially contiguous group of storage locations on a storage medium.

The third step of the four step method is the computation 7 of a similarity matrix 8 for hash values 4 that belong to each bucket 6 in turn (each bucket 6 being associated with a unique or substantially unique hash value 4).

Assuming that there are T buckets, each of which has N₁ points, where

$$0 \leq i \leq T - 1$$

$$and$$

$${\sum }_{i = 0}^{T - 1} {N}_{i} = N ,$$

the overall complexity of this step is

$${\sum }_{i = 0}^{T - 1} O ( {N}_{i}^{2} ) .$$

The computation 7 of a similarity matrix 8 may be achieved using a Gaussian kernel to compute a pair-wise similarity (Sₗₘ) between the hash values 4 (e.g. (Xₗ) and (Xₘ)) in each bucket 6:

$${S}_{Im}^{i} = {exp ( - \frac{‖ {X}_{l} - {X}_{m} ‖}{2 {σ}^{2}} )}^{2}$$

where σ is the kernel bandwidth, which controls how rapidly the similarity (Sₗₘⁱ) decays.

It will be appreciated that, in other embodiments, a different kernel could be used (i.e. a kernel other than a Gaussian kernel—for example, an Euclidean kernel.

A graphical user interface may allow user interaction with the generation of the similarity matrices 8. For example, the user may be able to selection, through the graphical user interface, how each similarity matrix 8 is generated.

The result of the third step is an approximated overall similarity matrix 81 for the data points 11 being analysed. The approximated overall similarity matrix 81 is, itself, formed of a similarity matrix 8 for each of the buckets 6.

The fourth step of the four step method is to apply a kernel-based machine learning algorithm such as spectral clustering 9 to the similarity matrix 8 for each bucket 6.

In embodiments, the first three steps of the method are independent of the fourth step and, therefore, the fourth step may comprise the implementation of any of a number of kernel-based machine learning algorithms. Indeed, the fourth step could comprise other, simpler, clustering methods—such as a k-means method. A machine learning algorithm could be used which is not necessarily a kernel-based machine learning algorithm.

Kernel-based methods include clustering, classification and dimensionality reduction methods.

In embodiments, a graphical user interface 103 may be provided to allow the user to select the machine learning algorithm 9 (or kernel-based machine learning algorithm) to be applied and/or one or more parameters for use in the application of the algorithm 9 (or kernel-based machine learning algorithm).

In embodiments, the fourth step may be performed by one or more processing units 104,202,203 which are different from the or each processing unit 104,202,203 which may have been used to perform the first three steps.

In an example embodiment, the fourth step comprises the application of a spectral clustering method.

Spectral clustering computes a Laplacian matrix L and eigenvectors of L. It then performs K-means clustering on a matrix of the computed eigenvectors.

In accordance with embodiments, the spectral clustering is applied to the approximated overall similarity matrix 81 determined in accordance with the third step above. As discussed above, the approximated overall similarity matrix 81 is composed of smaller similarity matrices 8 computed from each bucket 6.

The Laplacian matrix L for each similarity matrix 8, Sᵢ, of the approximated overall similarity matrix 81 can be determined using the following equation:

Lⁱ=Dⁱ^{^{−1/2}}SᵢDⁱ^{^{−1/2}}

Where Dⁱ^{^{−1/2}} is the inverse square root of Dⁱ and is a diagonal matrix.

For an Nᵢ×Nᵢ diagonal matrix, the complexity of finding the inverse square root is O(N).

Moreover, the complexity of multiplying an Nᵢ×Nᵢ diagonal matrix with an Nᵢ×Nᵢ matrix is O(Nᵢ²). Therefore, the complexity of this step is

$$O ( {\sum }_{i = 0}^{T - 1} {N}_{i}^{2} ) .$$

Once the Laplacian matrix has been calculated for each similarity matrix 8, then the eigenvectors are computed. The first K eigenvectors of the Laplacian matrix, Lᵢ, V₁ⁱ, V₂ⁱ, . . . , V_{K}_{ᵢ}ⁱ, form a matrix Xⁱ=└V₁ⁱV₂ⁱ . . . V_{K}_{ᵢ}ⁱ┘εR^{N}^{ᵢ}^{×K}^{ᵢ} by stacking the eigenvectors in columns.

The eigenvectors are using QR decomposition (which takes O(Kᵢ³) steps).

In embodiments, to reduce the computational complexity of this part of this step, the Laplacian matrix, Lⁱ, is transformed in a Kᵢ×Kᵢ symmetric triangular matrix Aⁱ. The complexity of this transformation is O(KᵢNᵢ). The QR decomposition is then applied to the symmetric triangular matrix, Aⁱ, which has a complexity of O(Kᵢ). Therefore, the complexity of this step is

$$O ( {\sum }_{i = 0}^{T - 1} ( {K}_{i} {N}_{i} ) ) .$$

The input vectors, Xᵢ, are normalised to have unit length such that

$${Y}_{ij} = {X}_{ij} / ( \sqrt{{\sum }_{j} {X}_{ij}^{2}} )$$

and Yᵢ is treated as a point in R^{K} and is clustered into Kᵢ clusters using K-means. The complexity of this step is

$$O ( {\sum }_{i = 0}^{T - 1} ( {K}_{i} {N}_{i} ) ) .$$

Adding the time cost of the above steps in this example embodiment discussed herein is:

$${T}_{DASC} = O ( MN ) + O ( {T}^{2} ) + {\sum }_{i = 0}^{T - 1} [ 2 O ( {N}_{i}^{2} ) + 2 ( {K}_{i} {N}_{i} ) ] + 2 N$$

As discussed above, embodiments of the present invention may be implemented using a distributed processing arrangement 200,201.

This may be done, for example, using the MapReduce framework or other suitable frameworks. In accordance with such implementations, the method (or part thereof) is broken into two phases: a map phase and a reduce phase.

The method of embodiments of the invention may be separated into a plurality of stages and each stage may be separated into two phases. The inputs and outputs of each phase are defined by key-value pairs.

In embodiments, the method is separated into two stages. In a first stage, the hashing step 3 is performed on the input data points 11 and produces hash values 4 (i.e. signature vectors)—as discussed above.

In the map phase of this first stage, the input data points are input as (index, inputVector) pairs—the “index” being the index of the data point 11 within the dataset 1, and the “inputVector” being a array (which may be a numerical array) associated with the data point 11 (i.e. the actual data point value).

The output key-value pair is (signature, index), where signature is a binary sequence of the signature vector (i.e. the hash value 4), and index is the same as the input notation.

The reducer phase of this first stage takes, as its input, (signature, listof(index)) pair, where “signature” is as stated above and “listof(index)” is a list of all vectors that share the same signature vector (i.e. hash value 4)—the “same” meaning that the hash values 4 (i.e. signature vectors) are duplicates or near duplicates or each other.

The reducer phase computes the similarity matrix Sₗₘⁱ, as discussed above.

Pseudocode for the map and reduce phase functions is shown below:

Algorithm 1: mapper (index, inputVector)

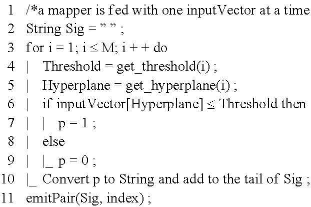

Algorithm 2: reducer (signature, ArrayList indexList)

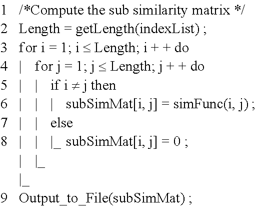

The hyperplane is the arbitrary dimension discussed above.

In embodiments, the arbitrary dimension (i.e. the hyperplane) and threshold may be selected using a k-dimensional (k-d) tree.

The k-d tree may be a binary tree in which every node is a k-dimensional point. Every non-leaf node can be thought of as implicitly generating a splitting hyperplane that divides the space into two parts, known as subspaces. Points to the left of this hyperplane are represented by a left subtree of that node and points right of the hyperplane are represented by a right subtree.

The hyperplane direction may be chosen by: associating every node in the tree with one of the k-dimensions, with the hyperplane perpendicular to that dimension's axis. For example, if for a particular split, the “x” axis is chosen, all points in the subtree with a smaller “x” value than the node will appear in the left subtree and all points with larger “x” value will be will in the right subtree. In such a case, the hyperplane would be set by the x-value of the point, and its normal would be the unit x-axis.

To determine the hyperplane array, each dimension of the dataset is considered, and the numerical span for all dimensions is calculated (denoted as span[i], iε[0, d]).

The numerical span is defined as the difference of the largest and the smallest values in this dimension. Dimensions are then ranked according to their numerical spans.

The possibility of one hyperplane being chosen in the hashing step 3 is:

$$prob = span [ i ] / {\sum }_{i = 0}^{d - 1} span [ i ]$$

which ensures that dimensions with large span have more chance of being selected.

For each dimension space Dim[i], the associated threshold may be determined by: creating a number of bins (for example 20 bins) between the minimum (min[i]) and the maximum (max[i]) of Dim[i]. The bins are denoted as bin[j], jε[0,19] in the example using 20 bins. bin[j] is used to store the number of points whose i th dimension falls into the range └min[i]+j×span[i]/20, min[i]+(j+1)×span[i]/20┘, again for the example with 20 bins.

The minimum in array bin (denoted as s) is determined and the threshold associated with Dim[i] is set to:

Dim[i]=min[i]+s×span[i]/20

Approximation error can occur if two relatively close points in the original input space are allocated to two different buckets 6.

In such circumstances, if a full similarity matrix had been computed from the original dataset 1, the similarity between the two data points 11 would have been significant. However, due to the approximation techniques discussed herein, the similarity may be missed.

In order to reduce this approximation error, pair-wise comparison may be performed between the bits of the hash values 4 associated with the buckets 6, and for buckets 6 represented by hash values 4 that share no less than P bits, the buckets 6 are combined. This step may be performed before applying the reducer. This step may equally be performed even in embodiments in which distributed processing is not implemented.

The process of comparing two M-bit hash values 4 A and B each associated with a respective bucket 6 may be optimised for performance using the bit manipulation:

ANS=(A⊕B)(A⊕B−1)

where if ANS is 0, then A and B have only one bit in difference, thus they will be merged together. Otherwise, A and B are not merged. This could be altered such that a difference of more than one bit will also result in merging of the buckets 6 associated with the hash values 4.

The complexity of this operation is O(1).

After computing the similarity matrices 8 and the approximated overall similarity matrix 81, a machine learning algorithm (or kernel-based machine learning algorithm) may be applied.

In embodiments, the threshold used in the hashing step 3 is determined by calculating a histogram of the data along the selected dimension and then setting the threshold to be the lower edge of the part of the histogram with the lowest count.

It will be appreciated that, as the number of buckets 6 used in embodiments increases (i.e. the degree of similarity between two hash values 4 which is required for the two hash values 4 to be placed in the same bucket 6 decreases), the higher the likelihood that, for example, two adjacent data points 11 will be allocated to different buckets 6—on the other hand, the greater the number of buckets 6, the greater the possible distribution of the analysis of the dataset 1 between a plurality of processing units 104,202,203. Therefore, there is a balance between accuracy and speed.

A graphical user interface may be provided which allows a user to balance various factors in the process in order to favour, for example, speed or accuracy.

As will also be appreciated restricting the number of bits in each hash value 4 will have a similar effect to increasing the number of buckets 6.

In embodiments, each bucket 6 is stored as an independent file on a storage medium. In embodiments, each file may include references to one or more other files which are each associated with a respective bucket 6.

Embodiments of the present invention may be used to identify duplicate web pages in a database held by a search engine. Analysis may be performed on whole documents (e.g. web pages) or summaries thereof. The web pages (or summaries) may, therefore, form the dataset 1.

Embodiments of the present invention may be used to identify patterns in image data. In such embodiments, the image data is the dataset 1.

Embodiments of the present invention may be used to detect weather patterns in weather data (including, for example, temperature, air pressure, wind speed, wind direction, humidity, and/or rainfall). In such embodiments, the weather data is the dataset 1.

Embodiments of the present invention may be used in the analysis of an audio recording of a natural language. In such embodiments, the audio recording (in digital form) is the dataset 1.

Embodiments of the present invention may be used in visual identification methods in which large numbers of visual features are extracted from an image database and clustering methods are used to construct a codebook from these features.

Embodiments of the present invention may be used to cluster gene expression data in which (in some applications) the number of genes and samples are available and the invention may be implemented to find gene signatures and/or population families

Grouping communities in social networking which share similar characteristics and/or interests is another application to which embodiments of the invention could be put to use.

Another application of embodiments of the present invention is object detection from visual information involved building classifiers which may have large features vectors.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method for processing at least part of a large-scale dataset, the method comprising:
receiving a dataset including a plurality of data points;
generating a hash value for at least some of the data points;
sorting the generated hash values into a plurality of buckets of identical or substantially identical hash values;
generating a similarity matrix for each of the buckets; and
applying a machine learning algorithm to the similarity matrices.

2. A method according to claim 1, further comprising allocating each of the plurality of buckets to a one of a plurality of processing units, each processing unit being configured to generate a similarity matrix for at least one of the plurality of buckets.

3. A method according to claim 2, wherein a first of the plurality of buckets is allocated to a first of the plurality of processing units, and a second of the plurality of buckets is allocated to a second of the plurality of processing units, the first and second processing units being different processing units.

4. A method according to claim 1, wherein each processing unit is remote from at least one other processing unit of the plurality of processing units.

5. A method according to claim 3, wherein the first and second processing units are parts of the same computing device.

6. A method according to claim 3, wherein the first and second processing units are parts of respective first and second computing devices.

7. A method according to claim 6, wherein the first and second computing devices are part of a distributed processing network.

8. A method according to claim 7, wherein the distributed processing network is a cloud computing network.

9. A method according to claim 1, wherein generating the hash value comprises applying a data-blind hashing technique.

10. A method according to claim 9, wherein generating the hash value comprises applying a locality sensitive hashing (LSH) technique.

11. A method according to claim 10, wherein generating the hash value comprises applying a random projection technique.

12. A method according to claim 10, wherein generating the hash value comprises applying a stable distribution technique.

13. A method according to claim 10, wherein generating the hash value comprises applying a Min-Wise Independent Permutations technique.

14. A method according to claim 1, wherein generating the hash value comprises applying a data-dependent hashing technique.

15. A method according to claim 1, wherein the machine learning algorithm is a clustering algorithm.

16. A computer readable medium storing instructions which when run on a computing device cause the operation of a method according to claim 1.

17. A data bucket for use in a method according to claim 1.

18. An apparatus configured to process at least part of a large-scale dataset, by:
receiving a dataset including a plurality of data points;
generating a hash value for at least some of the data points;
sorting the generated hash values into a plurality of buckets of identical or substantially identical hash values;
generating a similarity matrix for each of the buckets; and
applying a machine learning algorithm to the similarity matrices.

19. An apparatus according to claim 18, wherein the apparatus includes a plurality of processing units.

20. An apparatus according to claim 19, wherein the apparatus is further configured to allocating each of the plurality of buckets to a one of the plurality of processing units, each processing unit being configured to generate a similarity matrix for at least one of the plurality of buckets.

21. An apparatus according to claim 20, wherein a first of the plurality of buckets is allocated to a first of the plurality of processing units, and a second of the plurality of buckets is allocated to a second of the plurality of processing units, the first and second processing units being different processing units.

22. An apparatus according to claim 19, wherein each processing unit is remote from at least one other processing unit of the plurality of processing units.

23. An apparatus according to claim 22, wherein the first and second processing units are parts of the same computing device.

24. An apparatus according to claim 22, wherein the first and second processing units are parts of respective first and second computing devices.

25. An apparatus according to claim 24, wherein the first and second computing devices are part of a distributed processing network.

26. An apparatus according to claim 25, wherein the distributed processing network is a cloud computing network.

27. An apparatus according to claim 18, wherein generating the hash value comprises applying a data-blind hashing technique.

28. An apparatus according to claim 27, wherein generating the hash value comprises applying a locality sensitive hashing (LSH) technique.

29. An apparatus according to claim 28, wherein generating the hash value comprises applying a random projection technique.

30. An apparatus according to claim 28, wherein generating the hash value comprises applying a stable distribution technique.

31. An apparatus according to claim 28, wherein generating the hash value comprises applying a Min-Wise Independent Permutations technique.

32. An apparatus according to claim 18, wherein generating the hash value comprises applying a data-dependent hashing technique.

33. An apparatus according to claim 18, wherein the machine learning algorithm is a clustering algorithm.

34. A cloud computing network including an apparatus according to claim 18.
